(19) United States
(12) Patent Application Publication
(10) Pub. No.: US 2025/0183986 A1
(43) Pub. Date: Jun. 5, 2025

(54) METHODS, APPARATUS AND COMPUTER PROGRAMS FOR WIRELESS COMMUNICATIONS

(71) Applicant: Continental Automotive Technologies GmbH, Hannover (DE)

(72) Inventors: David Gonzalez Gonzalez, Egelsbach (DE); Reuben George Stephen, Singapore (SG); Shravan Kumar Kalyankar, Singapore (SG); Hojin Kim, Regensburg (DE); Rikin Shah, Langen (DE)

(73) Assignee: Continental Automotive Technologies GmbH, Hannover (DE)

(21) Appl. No.: 18/842,058

(22) PCT Filed: Feb. 27, 2023
(86) PCT No.: PCT/EP2023/054823

§ 371 Date: Aug. 28, 2024

(30) Foreign Application Priority Data
Feb. 28, 2022 (DE) 10 2022 202 051.0

(51) Int. Cl. H04B 7/06; H04W 72/25

(52) U.S. Cl. CPC H04B 7/06968; H04B 7/0626; H04W 72/25

(57) ABSTRACT

A quasi-colocation relation is determined at a first user equipment server by a network node in a wireless communication network by: discovering, using sidelink communications, a nearby second user equipment; negotiating at least one common reference signal with the second user equipment; determining, using the at least one common reference signal, a first estimate of at least one large-scale property of a first physical channel; receiving, from the second user equipment, at least a second estimate of said at least one large-scale property of a second physical channel; determining a quasi-colocation relation by comparing the first estimate and the second estimate; and notifying a network node of a quasi-colocation relation between the first user equipment and the second user equipment.

### CROSS-REFERENCE TO RELATED APPLICATIONS

The present application is a National Stage Application under 35 U.S.C. § 371 of International Patent Application No. PCT/EP2023/054823 filed on Feb. 27, 2023, and claims priority from German Patent Application No. 10 2022 202 051.0 filed on Feb. 28, 2022, in the German Patent and Trademark Office, the disclosures of which are herein incorporated by reference in their entireties.

### TECHNICAL FIELD

Aspects of the present disclosure relate to wireless communications, and particularly to a method for discovering, establishing, and notifying a quasi co-located (QCL) relation.

### BACKGROUND

Wireless communication systems are widely deployed and today offer a range of telecommunication services, such as telephony, video, data, messaging, etc. These wireless communication systems can use multi-access technologies that allow the sharing of available system resources among multiple users, such as long-term evolution (LTE) systems of the 3rd generation partnership (3GPP) project or LTE Advanced (LTE-A) systems among others.

A multi-access system generally includes a base station that supports simultaneous communications with a variety of user equipment. In LTE systems, these base stations are known as eNodeB (4G) or in case of 5G NR (New Radio), they are known as Next Generation Base Station, gNB or gNodeB.

Base stations communicate with one or more user equipment (UE) using downlink channels (DL) when transmitting from a base station (BS) to a user equipment, and uplink channels (UL) when transmitting from a user equipment to a base station.

5G NR is a new radio access technology developed and released by 3GPP for 5G mobile networks. NR is designed to better support mobile broadband Internet access by improving spectral efficiency, lowering costs, improving services, and making use of new spectrum.

To achieve high-rate transmissions, a User Equipment may determine characteristics of a downlink physical channel by performing channel estimation. Basically, channel estimation is the process of correlating a transmitted reference signal (RS) with the signal received to figure out the characteristics of the channel that the signal has gone through.

This makes it possible to adapt transmissions to current channel conditions, which is crucial for achieving reliable communication with high data rates in multiantenna systems.

To help User Equipment with channel estimation, 3GPP introduced the concept of Quasi-Colocation (QCL). In some cases, signals transmitted from different antenna ports may experience radio channels having common properties. In such cases the antenna ports are said to be “Quasi-Colocated” (QCL). Accordingly, a Base Station may inform a user equipment whether two antenna ports are QCL, and that a first and a second physical channels may have similar large-scale fading properties (i.e., Doppler Shift, Doppler Spread, Average Delay, Delay Spread). QLC indicator thus allows a User Equipment to save resources by computing channel estimates only once and apply the resulting characteristics to another QCL channel.

For example, if two antenna ports are determined as being QCL in terms of doppler spread, UE can determine the doppler spread for one antenna port and apply the result to both antenna ports. This avoids the UE having to determine the doppler spread separately for each antenna port.

Unfortunately, base stations do not benefit from QCL mechanism, i.e., QCL is only defined for antenna ports of the same logical gNB used to transmit downlink signals. However, as the demand for mobile broadband access continues to increase, there exists a need for further improvements in NR and LTE technology.

### BRIEF SUMMARY

What follows is a simplified summary of one or more aspects of the present disclosure, intended to provide a basic understanding of such aspects. This summary is not an extensive overview of all contemplated aspects and is intended to neither identify key or critical elements of all aspects nor delineate the scope of any or all aspects.

An embodiment of the present disclosure relates to a method for determining a quasi-colocation relation at a first user equipment in a wireless communication network, the method comprising:
Discovering, using sidelink communications, a nearby second user equipment,
Negotiating at least one common reference signal with the second user equipment,
Determining, using said at least one common reference signal, a first estimate of at least one large-scale property of a first physical channel,
Receiving, from the second user equipment, at least a second estimate of said at least one large-scale property of a second physical channel,
Determining a quasi-colocation relation by comparing the first estimate and the second estimate, and
Notifying a network node of a quasi-colocation relation between the first user equipment and the second user equipment.

Hence, the disclosed wireless method makes it possible for a first user equipment to determine that at least a second user equipment is quasi-colocated with at least one large scale fading characteristic. The first user equipment may then transmit this indication to a base station. The base station may then leverage this indication to optimize uplink channel sounding, downlink channel transmissions intended to any of the UE, save processing and optimize bandwidth usage, etc. As an example, when a first user equipment and a second user equipment are traveling in a same vehicle, they are moving at a same speed and relatively close to each other with respect to the distance to a gNB, they are moving in a same direction, and may experience same radio channel doppler disturbance. A base station knowing that both user equipment are quasi-colocated may leverage this knowledge and, for example, compute uplink channel parameters for one user equipment and apply the result to an uplink channel associated with the second user equipment.

In the following description, terms ‘large-scale property’, ‘large-scale parameter’, and ‘large-scale fading property/parameters’ will be used interchangeably, unless otherwise stated.

According to an embodiment, said at least one common reference signal includes a downlink reference signal.

When two nearby user equipment are traveling at a same speed in a same direction, it is likely that they experience similar downlink channel disturbance. Downlink reference signals may be used by a user equipment to figure out large-scale fading properties of a downlink physical radio channel between a base station to the user equipment.

According to an embodiment, said at least one common reference signal includes a sidelink reference signal.

Such a feature made it possible to determine a quasi-colocation relation between two user equipment even when devices are out of network coverage. Moreover, when more than one second user equipment are determined as quasi-colocated, the first user equipment can leverage the determined quasi-colocation relation to configure sidelink physical channels established with other nearby quasi-colocated devices.

According to a particular embodiment, the step of negotiating at least one common reference signal with the second user equipment includes:
Sending a message over a sidelink, the message comprising at least one reference signal identifier,
Receiving a message from said second user equipment, the message comprising at least one of said at least one reference signal identifier.

This way, a first user agent may agree on one or more common reference signals to use during QCL determination process.

According to another aspect of the present disclosure, it is proposed a method for configuring an uplink channel at a base station comprising:
Receiving, from a first user equipment, a quasi-colocation indication comprising at least an identity of a second user equipment,
Estimating at least one large-scale property of a first uplink physical channel associated with the first user equipment,
Configuring at least a second physical channel associated with the second user equipment according to the estimated at least one large-scale parameter.

The proposed method makes it possible for a base station to leverage the fact that two nearby user equipment are experiencing common disturbances by, for example, configuring a second uplink channel using estimations computed for a first uplink channel.

According to a particular embodiment, the step of configuring at least a second uplink physical channel associated with the second user equipment includes applying at least a same beamforming parameter for said first and at least second physical channels.

As first and second user equipment are determined QCL, a same beamforming parameter may be used to configure uplink and downlink channels associated with both user equipment.

According to a particular embodiment configuring at least a second uplink physical channel associated with the second user equipment includes reducing Channel State Information feedback rate.

According to a particular embodiment configuring at least a second uplink physical channel associated with the second user equipment includes reducing at least a reference signal transmission rate.

According to yet another aspect of the present disclosure, it is proposed a user equipment device for determining a quasi-colocation relation comprising a processor and a memory, the memory comprising computer program instructions adapted to configure the processor to perform the following steps:
Discovering, using sidelink communications, a nearby second user equipment,
Negotiating at least one common reference signal with the second user equipment,
Determining, using said at least one common reference signal, a first estimate of at least one large-scale property of a first physical channel,
Receiving, from the second user equipment, at least a second estimate of said at least one large-scale property of a second physical channel,
Determining a quasi-colocation relation by comparing the first estimate and the second estimate, and
Notifying a network node of a quasi-colocation relation between the first user equipment and the second user equipment.

According to yet another aspect of the present disclosure, it is proposed a vehicle comprising a user equipment device as described hereabove.

According to yet another aspect of the present disclosure, it is proposed a radio network node for configuring an uplink channel comprising a processor and a memory, the memory comprising computer program instructions adapted to configure the processor to perform the following steps:
Receiving, from a first user equipment, a quasi-colocation indication comprising at least an identity of a second user equipment,
Estimating at least one large-scale property of a first uplink physical channel associated with the first user equipment, and
Configuring at least a second physical channel associated with the second user equipment according to the estimated at least one large-scale parameter.

In a particular embodiment, the various steps of the quasi-colocation determination method and/or the uplink channel configuration method are determined by instructions of computer programs.

Consequently, an embodiment of the invention is also aimed at computer programs on an information medium, these programs being suitable to be implemented respectively in user equipment and network node devices or more generally in a computer, these programs respectively comprising instructions adapted to implement the steps of the quasi-colocation determination method and/or the uplink channel configuration method which have just been described.

These programs can use any programming language, and be in the form of source code, object code, or of code intermediate between source code and object code, such as in a partially compiled form, or in any other desirable form.

An embodiment is also aimed at an information medium readable by a computer comprising instructions of a computer program such as mentioned hereinabove.

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may in particular be downloaded from a network.

Alternatively, the information medium may be an integrated circuit into which the program is incorporated, the circuit being adapted to execute or to be used in the execution of the methods in question.

The advantages of the user equipment for determining a quasi-colocation relation, of the vehicle comprising such user equipment, of the corresponding computer program and information medium are identical to those presented in relation with the corresponding method according to any one of the particular embodiments mentioned hereinabove.

The advantages of the network node for configuring an uplink channel, and corresponding computer program and information medium are identical to those presented in relation with the corresponding method according to any one of the particular embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings, among which:

FIG. 1 shows a schematic representation of a radio communication network.

FIG. 2 shows a flow chart depicting main steps of a method for determining a quasi-colocation relation according to a particular embodiment.

FIG. 3 shows combined flow chart and signaling scheme according to a particular embodiment of a method for determining a quasi-colocation relation.

FIG. 4 shows combined flow chart and signaling scheme according to a particular embodiment of a method for determining a quasi-colocation relation.

FIG. 5 is a block diagram depicting an apparatus for determining a quasi-colocation relation according to a particular embodiment.

### DETAILED DESCRIPTION

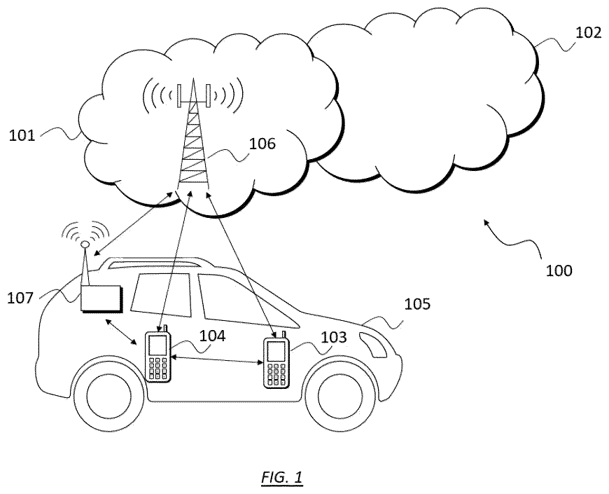

FIG. 1 shows a schematic representation of a radio communication network 100. The radio communication network 100 comprises at least a Radio Access Network (RAN) 101 and a Core Network 102. In some implementation, the radio communication network 100 may be long-term evolution (LTE) system, an LTE Advanced (LTE-A) system, WCDMA, 5G, 6G, etc. Note that although terminology from 3GPP LTE may be used in this disclosure to exemplify embodiments herein, this should not be seen as limiting the scope of the invention.

FIG. 1 also shows a first user equipment 103 and a second user equipment 104 and a third user equipment 107 configured to communicate with RAN 101. It is to be understood that the term “user equipment” is not limiting and refers to any wireless terminal or mobile station configured to communicate with RAN 101. In some implementation, user equipment 107 may be an Intelligent Antenna Module (IAM), a Telematic Control Unit (TCU), a Network Access Device (NAD), a sensor, relay, or whatever wireless communication device mounted in a car 105. User equipment 103, 104 may be a mobile station, for example a mobile phone, tablet or laptop.

RAN 101 comprises a base station 106 responsible for serving a cell in which user equipment 103 and 104 are located. The base station 106 may be referred as eNodeB (eNB), gNodeB (gNB) or any network equipment adapted to provide wireless access and communicate with user equipment 103, 104 and 107, depending on the radio access technology implemented and the terminology.

Base station 106 communicates with user equipment 103, 104 and 107 using downlink (DL) radio channels when transmitting to a user equipment, and uplink (UL) radio channels when receiving from a user equipment.

In order to achieve high rate and error prone transmission over both downlink and uplink channel, wireless transmissions between a user equipment and a base station include reference signals (RS). A purpose of a reference signal may be to help a receiver demodulate a received signal. Since a reference signal is made up of data known to both transmitter and receiver, the receiver can figure out how the communication channel distort the data by comparing the decoded received reference signal and original reference signal. The result of this comparison may be used to equalize the received user data using post-processing. This task is called “Channel Estimation” and is a critical part of many high-end wireless communication like LTE.

In order to help user equipment with channel estimation, 3GPP introduced the concept of Quasi-colocation (QCL). Basically, even if a base station is transmitting data over different physical channels using distinct antenna ports, these channels may still have common large-scale properties like Doppler Shift, Doppler Spread, Average Delay, Delay Spread or Spatial Receiver Parameters.

Hence, a user equipment may consider that downlink physical channels associated with distinct antenna ports may have a same set of large-scale properties if they are specified as QCL. Practically, a base station may indicate to a user equipment that two antenna ports are QCL by transmitting a TCI (Transmission condition Indicator) state. A base station may configure TCI states using RRC (Radio Resource Control) configurations.

When a user equipment is informed that radio channels corresponding to two different antenna ports are QCL in terms of, e.g., Doppler shift, the user equipment can then determine Doppler shift for one antenna port and then apply the result on both antenna ports for channel estimation. This avoids the user equipment to calculate doppler for both antennas port separately. This helps reducing complexity and energy consumption and increase reliability.

However, only user equipment could benefit from a QCL relation.

At least some aspects of the present disclosure provide means and methods to determine and leverage a QCL relation between at least a first and a second user equipment in a wireless communication network. For example, a first and a second user equipment traveling inside a same vehicle (for example in a car, a train, a bus, subway, etc.) may experience similar radio channel properties like doppler-related features (i.e., doppler spread or doppler shift) as they are moving in the same direction, at a same speed, with a constant proximity.

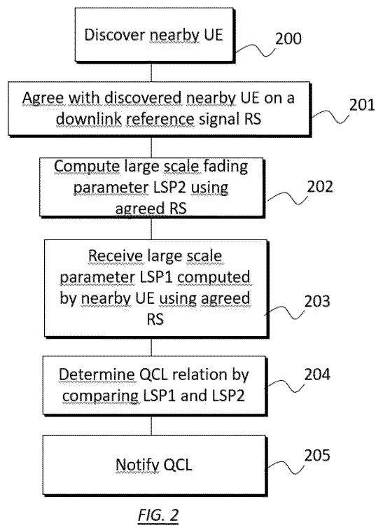

FIG. 2 shows a flow chart depicting a method at a first user equipment (UE1) for determining a QCL relation with a second user equipment (UE2) according to a particular embodiment.

Step 200 includes discovering a nearby user equipment UE2 using sidelink communication. In some implementation, the discovery step 200 may be based on Proximity Services (ProSe) framework as introduced in 3GPP Release 12. However, it should be understood that the use of ProSe framework should not be seen as a limitation of the scope of the present invention, since some other device to device (D2D) communication standards may be used to achieve a similar effect.

By introducing the Proximity Services (ProSe) functionalities in its 12th release, the 3GPP made it possible to perform device-to-device (D2D) communication in Long Term Evolution-Advanced (LTE-A) cellular network. Direct communication between nearby user equipment is then enabled through the newly introduced sidelink.

A user equipment may communicate with nearby user equipment through ProSe PC5 interface as defined in 3GPP Release 12. A user equipment may discover nearby user equipment using Physical Sidelink Discovery Channel (PSDCH) for direct discovery.

In one embodiment, the first user equipment UE1 may broadcast a discovery message. The discovery broadcast message may be sent over a Physical Sidelink Discovery Channel (PSDCH). The discovery message may include a QCL specific information so that a receiving user equipment may understand that the sending UE1 is trying to discover a QCL user equipment. The QCL-specific information may comprise at least dedicated ProSe application ID. The ProSe Application ID is an identity used for open ProSe Direct Discovery, identifying application related information for the ProSe-enabled user equipment.

For example, the ProSe discovery step 200 may use direct discovery model B as defined in 3GPP TS 29.343 according to which a discoverer user equipment (UE1) may transmit a request containing information about what it is interested to discover and expects a response from a discoveree user equipment (UE2) comprising information related to discoverer's UE1 request.

During a negotiation step 201, UE1 and UE2 agree on common resources including at least a reference signal RS to use to estimate channel properties. In some embodiment, the reference signal may be a downlink reference signal indicated by a base station using system information or MAC-level signaling.

In some embodiment, the reference signal may be a sidelink reference signal. In yet another embodiment, user equipment may agree on resource including both a downlink reference signal and a sidelink reference signal.

The negotiation step 201 may rely on discovery request and response to exchange resources. For example, the discovery message sent by discoverer UE1 may comprise a reference signal proposal, and the response sent by the discoveree UE2 may acknowledge the proposed reference signal or include an alternate reference signal proposal.

A reference signal proposal may be indicated using a reference signal identifier. For example, a reference signal identifier may be an index corresponding to a particular reference signal in a common array of N reference signals preconfigured in both user UE1 and UE2. According to yet another example wherein a same array of 8 reference signals is preconfigured within both UE1 and UE2, a particular reference signal may be indicated by 8 bits field.

Let's consider the following reference signals array is preconfigured on both UE1 and UE2:
[RS1, RS2, RS3, RS4, RS5, RS6, RS7, RS8]

UE1 may propose using RS1 and RS4 by transmitting the binary value “10010000” to the discovered UE2. UE2 may then select RS4 by sending a response containing the binary value “00010000”.

Once both discoverer UE1 and discoveree UE2 have agreed on at least a reference signal, UE1 estimates at least one large-scale parameter using said reference signal. For example, UE1 may estimate a doppler shift and/or a doppler spread by comparing preconfigured version of the agreed reference signal with said reference signal actually received.

If both UE agreed on a downlink reference signal, UE1 may estimate a large-scale channel parameter by comparing a preconfigured version of the agreed downlink reference signal with said downlink reference signal actually received from a base station.

In case both UE agreed on a sidelink reference signal, UE1 may estimate a large-scale channel parameter by comparing a preconfigured version of the agreed sidelink reference signal with said sidelink reference signal actually received from discovered UE2.

During step 203, discoverer UE1 receives from discoveree UE2 at least one large-scale channel parameter estimated by UE2 on the same basis as discoverer UE1, that is to say by comparing a preconfigured version of the agreed reference signal with said reference signal actually received by UE2.

During a step 204, discoverer UE1 determines a QCL relations between discoverer UE1 and discoveree UE2, the determination step 204 including at least a comparison of its own estimation of the at least one large-scale parameter with the at least one large-scale parameter estimated by discoveree UE2 received at step 203. For example, if a difference between a doppler-shift value estimated by UE1 and a doppler-shift value estimated by UE2 is below a particular threshold, UE1 may determine that UE1 and UE2 are QCL in terms of doppler-shift.

At step 205, the discoverer UE1 notifies the base station of the determined QCL relation. In some embodiments, UE1 may notify the base station by sending a message over a Physical Uplink Shared Channel (PUSCH) containing a QCL indication. According to another embodiment, UE1 may notify the base station through a UCI (Uplink Channel Information) sent over a Physical Uplink Control Channel (PUCCH), for example by sending a UCI without data.

The notification step 205 may also include sending a QCL confirmation to user equipment UE2, the QCL information may comprise a QCL type indication.

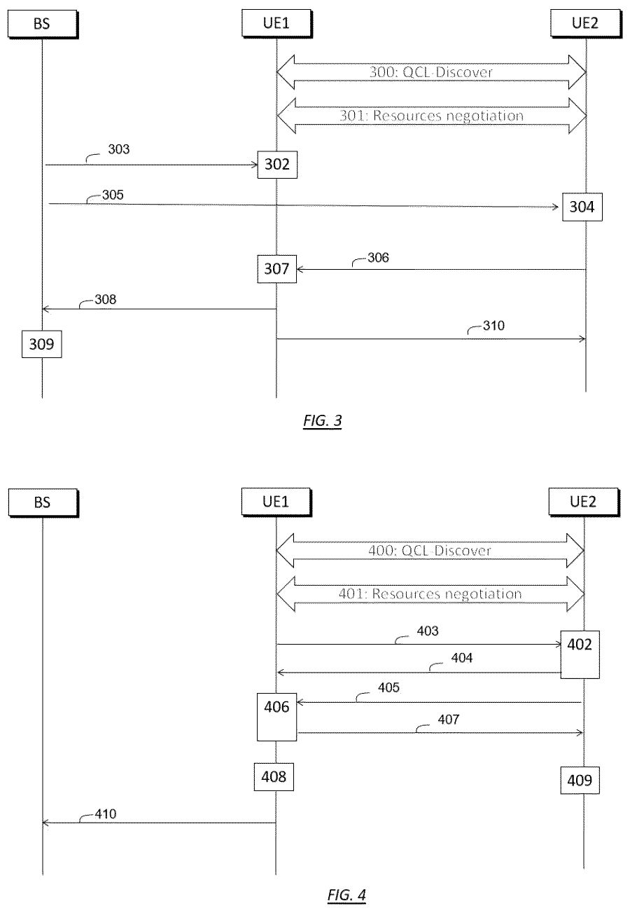

FIG. 3 is a combined flow chart and signaling scheme according to a particular embodiment.

FIG. 3 shows a discovery phase 300 during which a first user equipment UE1 discovers a second user equipment UE2 that support QCL determination. The discovery phase 300 may include the first user equipment (UE1) sending a QCL-Discover message to the second user equipment UE2 and the second user equipment UE2 sending a response to the first user equipment UE1. The QCL-Discover message may include specific QCL related resources, such as QCL-specific ProSe application ID.

FIG. 3 also shows a negotiation phase 301 during which first user equipment UE1 and second user equipment UE2 agree on common resources to carry out QCL relation determination. The negotiation phase 301 includes the first user equipment UE1 proposing at least a particular downlink reference signal to the second user equipment UE2, and the second user equipment UE2 acknowledging the proposed downlink reference signal. The negotiation phase may include several messages exchanges until both UE1 and UE2 agree on common resources. The negotiation phase 301 may include messages exchanged during the discovery phase 300 (i.e., the discovery message may include a reference signal proposal, and the discovery response may carry a reference signal acknowledgment) and/or dedicated subsequent messages.

FIG. 3 shows a large-scale parameter estimation step 302 carried out by the first user equipment UE1 upon reception of a downlink reference signal 303 from a base station BS that corresponds to the downlink reference signal agreed during the negotiation phase 301. During step 302, UE1 computes at least one large scale property of a physical radio channel established between UE1 and base station BS. For example, UE1 may estimate Doppler Shift, Doppler Spread, Average Delay, Delay Spread or Spatial Receiver Parameters by comparing a preconfigured version of the downlink reference signal with a downlink reference signal actually received from the base station BS.

FIG. 3 shows a large-scale parameter estimation step 304 carried out by the second user equipment UE2 upon reception of a downlink reference signal 305 from a base station BS that corresponds to the downlink reference signal agreed during the negotiation phase 301. During step 304, UE2 computes at least one large scale property of a physical radio channel established between UE2 and base station BS. For example, UE2 may estimate Doppler Shift, Doppler Spread, Average Delay, Delay Spread or Spatial Receiver Parameters by comparing a preconfigured version of the downlink reference signal with a downlink reference signal actually received from the base station BS.

UE2 transmits the result of the estimation step 304 to UE1 in a message 306.

Upon reception of the message 306 including estimation results sent by user equipment UE2, the first user equipment UE1 performs a QCL determination step 307. The QCL determination step 307 includes comparing the large-scale parameter estimates computed during step 302 with the large-scale parameter estimates computed by the second user equipment UE2 and received in the message 306. By comparing such parameters, the first user equipment may figure out if the discovered user equipment UE2 is experiencing similar downlink channel properties. In some implementations, the determination step 307 may further include obtaining and/or computing and comparing at least user equipment localizations. Such localization may be obtained through GNSS (Global Navigation Satellite Systems), UWB (Ultra Wide Band) or BLE (Bluetooth Low Energy) localization systems and/or other parameters like signal attenuation, Doppler characteristics, etc.

In case the first user equipment UE1 determines that UE2 is experiencing similar downlink channel properties regarding at least one large-scale parameter, the first user equipment notifies the base station BS of a QCL relation between UE1 and UE2 by sending a QCL information in a message 308. The message 308 includes at least an identifier of the second user equipment UE2 and a QCL information. The QCL information may indicate which large-scale channel characteristics are common across UE1 and UE2.

The base station BS may use the received QCL indication during a step 309 to configure uplink and/or downlink channels accordingly. In some implementation, the base station may apply at least a same beamforming parameter for a first and a second uplink and downlink physical channels associated with QCL user equipment, reduce Channel State Information feedback rate, or adjust a reference signal transmission rate.

User equipment UE1 may further confirm the QCL relation to user equipment UE2 by sending a QCL information in a message 310. The QCL information may comprise a QCL type indication.

FIG. 4 is a combined flow chart and signaling scheme according to another particular embodiment.

FIG. 4 shows a discovery phase 400 during which a first user equipment UE1 discovers a second user equipment UE2 that support QCL determination. The discovery phase 400 may include the first user equipment (UE1) sending a QCL-Discover message to the second user equipment UE2 and the second user equipment UE2 sending a response to the first user equipment UE1. The QCL-Discover message may include specific QCL related resources, such as QCL-specific ProSe application ID.

FIG. 4 also shows a negotiation phase 401 during which first user equipment UE1 and second user equipment UE2 agree on common resources to carry out QCL relation determination. The negotiation phase 401 includes the first user equipment UE1 proposing at least a particular sidelink reference signal to the second user equipment UE2, and the second user equipment UE2 acknowledging the proposed sidelink reference signal. The negotiation phase may include several messages exchanges until both UE1 and UE2 agree on common resources. The negotiation phase 401 may include messages exchanged during the discovery phase 400 (i.e., the discovery message may include a sidelink reference signal proposal, and the discovery response may carry a sidelink reference signal acknowledgment) and/or dedicated subsequent messages.

When both UE1 and UE2 have agreed on a particular sidelink reference signal, UE2 computes at least one large-scale parameter during an estimation step 402 by comparing the agreed sidelink reference signal transmitted by UE1 in a message 403 with a preconfigured version of said sidelink reference signal. For example, UE2 may estimate Doppler Shift, Doppler Spread, Average Delay, Delay Spread or Spatial Receiver Parameters. UE2 then sends the estimation results to UE1 in a message 404.

UE1 also computes at least one large-scale parameter during an estimation step 406 by comparing the agreed sidelink reference signal transmitted by UE2 in a message 405 with a preconfigured version of said sidelink reference signal. For example, UE1 may estimate Doppler Shift, Doppler Spread, Average Delay, Delay Spread or Spatial Receiver Parameters. UE1 then send the estimation results to UE2 in a message 407.

During a step 408, UE1 compare its own estimates of large-scale properties with the estimates computed by UE2 and received in message 404 to determine a QCL relation. Also, UE2 compares, at step 409, its own estimates with estimates provided by UE1 through message 407 in order to achieve QCL determination.

In some implementations, comparison steps 408 and 409 may further include obtaining and/or computing and comparing at least user equipment localizations. Such localization may be obtained through GNSS (Global Navigation Satellite Systems), UWB (Ultra Wide Band) or BLE (Bluetooth Low Energy) localization systems and/or other parameters like signal attenuation, Doppler characteristics, etc.

At least one user equipment UE1 may further provide a QCL indication to the base station BS through a message 410. As the determination result of each UE is reported to the other, they both know whether the QCL relationship holds or not, and only one of the UE would notify the network.

It is to be noted that embodiments previously described with reference to FIG. 3 and FIG. 4 may be combined so that QCL relation is determined on the basis of both downlink reference signal and sidelink reference signal.

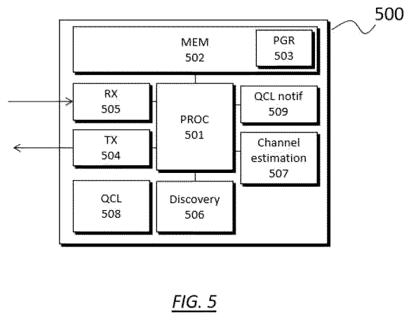

FIG. 5 shows a schematic architecture of a user equipment 500, according to embodiments herein, for determining a QCL relation between the user equipment 500 and a second user equipment.

The user equipment 500 comprises a processor 501 and a memory 502, for example a Random Access Memory (RAM). The processor may be controlled by a computer program 503 stored in the memory 502 comprising instructions configured to implement a method of determining a QCL relation according a particular embodiment.

More precisely, the computer program 503 comprises instructions to implements steps of:
Discovering, using sidelink communications, a nearby user equipment with QCL determination capabilities,
Determining at least one common reference signal with the discovered user equipment,
Determining, using said common reference signal, a first estimate of at least one large-scale parameter of a physical channel,
Receiving, from the discovered user equipment, at least a second estimate of said at least one large-scale parameter of a physical channel, wherein the second estimate is determined by the discovered user equipment using said common reference signal,
Determining a QCL relation by comparing the first estimate and the second estimate, and
Notifying a network node of a quasi-colocation relation between the user equipment 500 and the discovered user equipment.

On initialization, the instructions of the computer program 503 may be loaded into the memory 502 before being executed by the processor 501. The processor 501 implements the steps of the method according to the instructions of the computer program 603.

The user equipment 500 further comprises a wireless transmitter unit 504 that may be configured to transmit messages over sidelink communication and to transmit messages to a base station using uplink channels, and a wireless receiver unit 505 that may be configured to receive data from a nearby device using sidelink communication and/or to receive data sent by a base station over a downlink channel.

Furthermore, the user equipment 500 comprises a discovery unit 506. The discovery unit 506 may configure the wireless transmitter 504 to broadcast a sidelink discover message comprising at least a dedicated QCL application ID and a reference signal identifier. The discovery unit may also configure the wireless receiver unit 505 to receive a discover response message sent by a nearby user equipment supporting the dedicated QCL application ID, the response message comprising an agreement to use the reference signal proposed in the discover message.

The user equipment 500 also comprises a channel estimation unit 507. The channel estimation unit 507 may configure the wireless receiver unit 505 to receive, over a radio channel, a reference signal corresponding to the reference signal agreed with the discovered user equipment, and to compare said received reference signal with a preconfigured version of said reference signal in order to determine a first estimate of at least one large-scale property of the radio channel carrying the received reference signal.

The user equipment 500 further comprises a QCL determination unit 508. The QCL determination unit 508 may configure the wireless receiver 505 to receive from the discovered user equipment, at least a second estimate of said at least one large-scale property of the radio channel, wherein the second estimate is determined by the discovered user equipment using said agreed reference signal. The QCL determination unit 508 may further compare the first estimate computed by channel estimation unit 507 and the second estimate received by the receiver unit 505 and, depending on the result of the comparison, determine a QCL information indicating whether a QCL relation exists between user equipment 500 and the discovered user equipment. The QCL information may be determined by the determination unit 508 so as to indicate which of a set of large-scale parameters is shared by user equipment 500 and the discovered equipment.

Furthermore, the user equipment 500 comprises a QCL notification unit 509. The QCL notification unit 509 may configure the wireless transmitter 504 to transmit the QCL information determined by the QCL determination unit 508 to a base station.

According to an embodiment, user equipment 500 may be integrated in a vehicle, like a car, a truck, a train, etc.

1. A method for determining a quasi-colocation relation at a first user equipment in a wireless communication network, the method comprising:
Discovering, using sidelink communications, a nearby second user equipment,
Negotiating at least one common reference signal with the second user equipment,
Determining, using said at least one common reference signal, a first estimate of at least one large-scale property of a first physical channel,
Receiving, from the second user equipment, at least a second estimate of said at least one large-scale property of a second physical channel,
Determining a quasi-colocation relation by comparing the first estimate and the second estimate, and
Notifying a network node of a quasi-colocation relation between the first user equipment and the second user equipment.

2. The method according to claim 1 wherein said at least one common reference signal includes a downlink reference signal.

3. The method according to claim 1 wherein said at least one common reference signal includes a sidelink reference signal.

4. The method according to claim 1 wherein negotiating at least one common reference signal with the second user equipment includes:
Sending a message over a sidelink, the message comprising at least one reference signal identifier,
Receiving a message from said second user equipment, the message comprising at least one of said at least one reference signal identifier.

5. A method for configuring an uplink channel at a network node in a wireless network comprising:
Receiving, from a first user equipment, a quasi-colocation indication comprising at least an identity of a second user equipment,
Estimating at least one large-scale property of a first uplink physical channel associated with the first user equipment,
Configuring at least a second physical channel associated with the second user equipment according to the estimated at least one large-scale parameter.

6. The method according to claim 5 wherein configuring at least a second uplink physical channel associated with the second user equipment includes applying at least a same beamforming parameter for said first and second uplink physical channels.

7. The method according to claim 5 wherein configuring at least a second uplink physical channel associated with the second user equipment includes reducing Channel State Information feedback rate.

8. The method according to claim 5 wherein configuring at least a second uplink physical channel associated with the second user equipment includes reducing at least a reference signal transmission rate.

9. A user equipment for determining a quasi-colocation relation comprising a processor and a memory, the memory comprising computer program instructions adapted to configure the processor to perform the following steps:
Discovering, using sidelink communications, a nearby second user equipment,
Negotiating at least one common reference signal with the second user equipment,
Determining, using said at least one common reference signal, a first estimate of at least one large-scale property of a first physical channel,
Receiving, from the second user equipment, at least a second estimate of said at least one large-scale property of a second physical channel,
Determining a quasi-colocation relation by comparing the first estimate and the second estimate, and
Notifying a network node of a quasi-colocation relation between the first user equipment and the second user equipment.

10. (canceled)

11. A wireless network node for configuring an uplink channel comprising a processor and a memory, the memory comprising computer program instructions adapted to configure the processor to perform the following steps:
Receiving, from a first user equipment, a quasi-colocation indication comprising at least an identity of a second user equipment,
Estimating at least one large-scale property of a first uplink physical channel associated with the first user equipment, and
Configuring at least a second physical channel associated with the second user equipment according to the estimated at least one large-scale parameter.

12. (canceled)

13. (canceled)

14. The user equipment according to claim 9 wherein said at least one common reference signal includes a downlink reference signal.

15. The user equipment according to claim 9 wherein said at least one common reference signal includes a sidelink reference signal.
